(19) United States
(12) Patent Application Publication
(10) Pub. No.: US 2006/0230955 A1
(43) Pub. Date: Oct. 19, 2006

(54) Printing unit of a web-fed rotary press

(75) Inventors: Stefan Albrecht, Neusass (DE); Rainer Burger, Augsburg (DE); Norbert Dylla, Stadtbergen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/404,479

(22) Filed: Apr. 13, 2006

(30) Foreign Application Priority Data
Apr. 13, 2005 (DE) 10 2005 017 179.6

(51) Int. Cl. B41F 7/02

(52) U.S. Cl. 101/217

(57) ABSTRACT

A printing unit of a web-fed rotary press has a plurality of press, each press unit having a forme cylinder, a transfer, an inking unit and optionally a damping unit, and having at least one impression cylinder. Each forme cylinder rolls on the transfer cylinder of the respective press unit and each transfer cylinder rolling on an impression cylinder in a thrown-on position of the printing unit, in order to apply single-color printed images onto a printing material which is moved through between the transfer cylinders and the or each impression cylinder. The forme cylinders and/or the transfer cylinders are positioned asymmetrically.

### BACKGROUND OF THE INVENTION

1. Field of the Invention

The invention relates to a printing unit of a web-fed rotary press having a plurality of press units and at least one impression cylinder, each press unit having a printing cylinder and a transfer cylinder for printing single color images on a web.

2. Description of the Related Art

Printing units of web-fed rotary presses, in particular of newspaper presses, have a plurality of press units, each press unit comprising a transfer cylinder, a forme cylinder and an inking unit, and optionally a damping unit. The forme cylinders are also called plate cylinders and the transfer cylinders are also called blanket cylinders. Furthermore printing units of this type can have impression cylinders, it being possible for one impression cylinder to interact with one or more transfer cylinders of different press units. The transfer cylinders are also called satellite cylinders. In addition to printing units which have impression cylinders of this type, printing units are also known which do not have impression cylinders, the transfer cylinders of two press units rolling on one another in printing units of this type without impression cylinders. Accordingly, a web-fed rotary printing unit having a plurality of press units comprises a plurality of forme cylinders and a plurality of transfer cylinders and optionally one or more impression cylinders. The present invention relates to printing units which have a plurality of forme cylinders, a plurality of transfer cylinders and at least one impression cylinder. Printing units of this type are also called satellite printing units. Satellite printing units of web-fed rotary presses usually have four press units and accordingly four forme cylinders and four transfer cylinders and one or two impression cylinders. Satellite printing units of this type having four press units and one impression cylinder are called nine-cylinder printing units; printing units having four press units and two impression cylinders are called ten-cylinder printing units, in contrast.

In a satellite printing unit of this type, single-color printed images for preferably a plurality of printed pages are applied in the region of each press unit in one printing color onto the printing material which is moved through between the transfer cylinders and the or each impression cylinder. For this purpose, in what is known as a thrown-on position of the printing unit, a pressure has to be applied firstly between the forme cylinders and the transfer cylinders of the press units and secondly between the transfer cylinders and the respective impression cylinders, this pressure being provided by pivoting in or throwing on the transfer cylinders to the respective forme cylinder and to the respective impression cylinder. For this purpose, the transfer cylinders are usually mounted eccentrically and positioned relative to the respective forme cylinder and impression cylinder in such a way that a center point of the transfer cylinders does not lie on a connecting line between center points of the corresponding forme cylinders and impression cylinders. Rather, a connecting line of a center point of a transfer cylinder with the center point of the corresponding impression cylinder encloses an angle between 50 and 400 with the connecting line of the center points of the corresponding forme cylinders and impression cylinders. Here, however, the transfer cylinders and forme cylinders are arranged symmetrically with respect to one another, with regard to a vertically extending axis.

The transfer cylinders, the forme cylinders and the or each impression cylinder of printing units of this type are subjected to deflection on account of their inherent weight and on account of the pressure or contact forces. This deflection depends, in particular, on the design of the cylinders, relatively thin cylinders being subjected to a relatively pronounced deflection. As a result of the deflection of the transfer cylinders and forme cylinders and impression cylinders, a considerable deviation in the circumferential register can be produced between the single-color printed images which are to be printed in the different press units of the printing unit, which deviation impairs the print quality. As has already been mentioned, these deviations in the circumferential register are particularly pronounced when relatively thin cylinders are present.

In relatively thin cylinders, the ratio of printed pages which are positioned next to one another axially to printed pages which are positioned behind one another in the circumferential direction is great, as, for example, in 6/2 cylinders in which six printed pages are positioned next to one another in the axial direction and in each case two printed pages are positioned behind one another in the circumferential direction. The same is true for 3/1 cylinders and 4/1 cylinders.

### SUMMARY OF THE INVENTION

Proceeding from this, the present invention is based on the problem of providing a novel printing unit of a web-fed rotary press having minimized deviations in the circumferential register.

According to the invention, the forme cylinders and/or the transfer cylinders are positioned asymmetrically. The deflection of the cylinders can be influenced with the asymmetrical arrangement of the forme cylinders and/or transfer cylinders of the printing unit, in order thus to minimize deviations in the circumferential register. As a result, the print quality can be increased considerably.

The forme cylinders and/or the transfer cylinders are preferably positioned asymmetrically with respect to a vertically extending axis, this axis extending through the rotational axis of the impression cylinder in a printing unit having one impression cylinder. In contrast, in a printing unit having two impression cylinders, the impression cylinders are positioned symmetrically with respect to this axis.

The forme cylinders and/or the transfer cylinders are positioned asymmetrically in such a way that, in the region of all the press units, horizontal lines during the transfer of the or each printing forme onto the printing material are curved uniformly and, in relation to the transport direction of the printing material, in the same direction.

Accordingly, in the region of all the press units, the transfer cylinders are positioned downstream of and behind or upstream and in front of a connecting line which extends through the center points of the forme cylinder and impression cylinder of the respective press unit, in relation to the transport direction of the printing material.

Preferred developments of the invention result from the following description. Without being restricted thereto, exemplary embodiments of the invention will be explained in greater detail using the drawing.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic end view of a printing unit of a web-fed rotary press according to the prior art;

FIG. 2 is a plot showing a deviation in the circumferential direction which is produced in the press unit of FIG. 1;

FIG. 3 is a schematic end view of a printing unit of a web-fed rotary press, according to a first exemplary embodiment of the invention; and

FIG. 4 is a schematic end view of a printing unit of a web-fed rotary press, according to a second exemplary embodiment of the invention.

### DETAILED DESCRIPTION OF THE PRESENTLY PREFERRED EMBODIMENTS

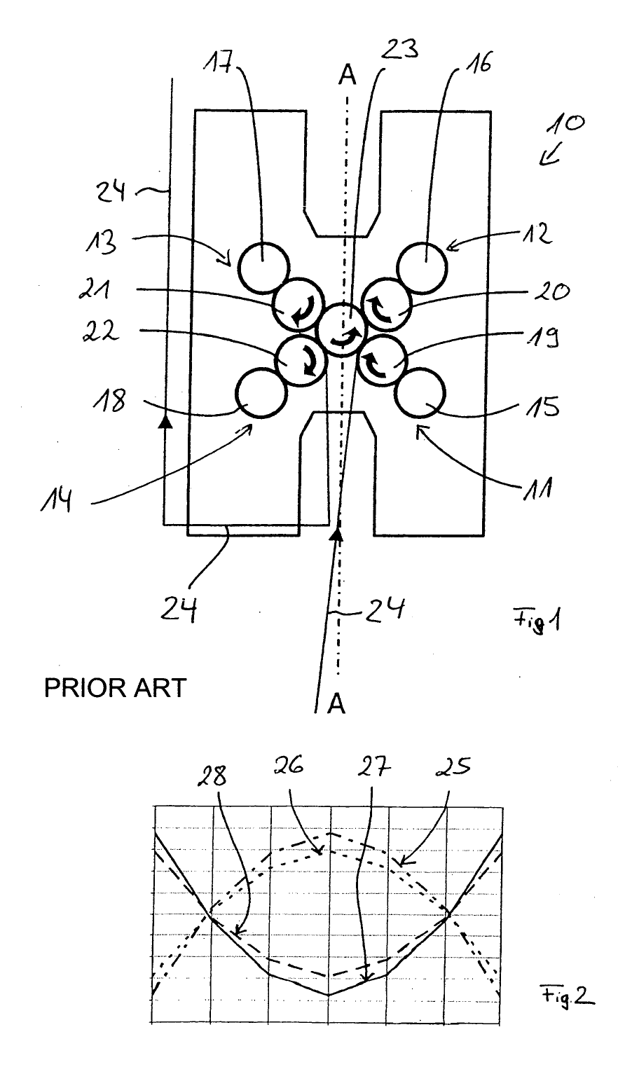

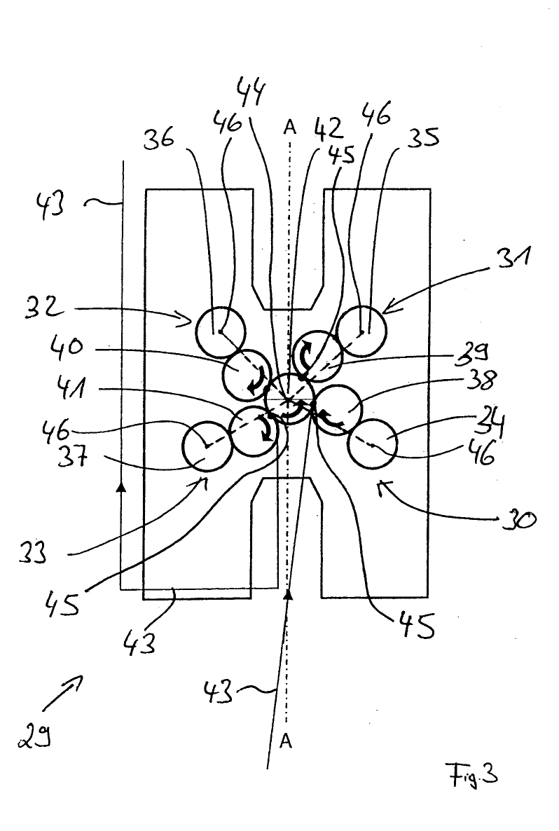

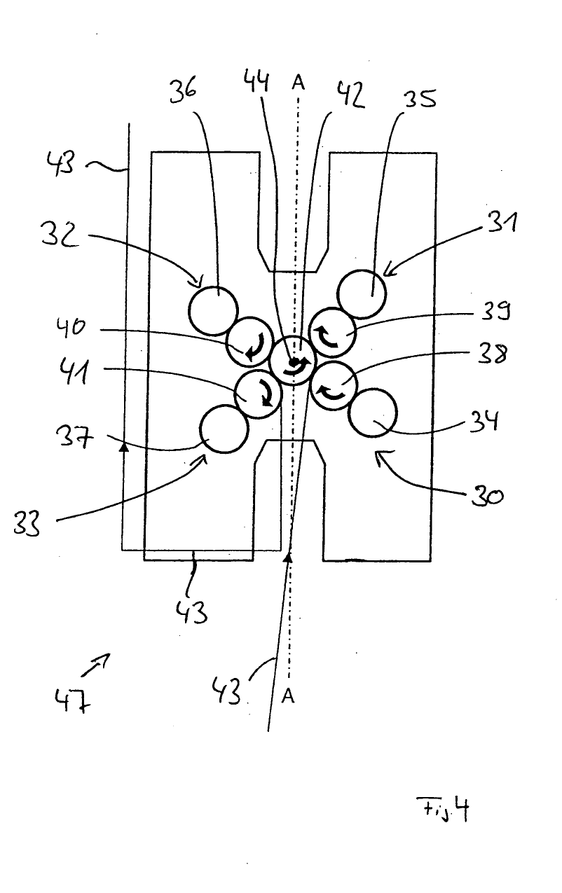

Before the invention is described in greater detail in the following text with reference to FIGS. 3 and 4, a printing unit which is known from the prior art of a web-fed rotary press, namely a newspaper press, will be described with reference to FIGS. 1 and 2.

FIG. 1 shows a printing unit 10, known from the prior art, of a web-fed rotary press, the printing unit 10 including four press units 11, 12, 13 and 14 and, accordingly, four forme cylinders 15, 16, 17 and 18, and four transfer cylinders 19, 20, 21 and 22. In addition to the forme cylinders 15 to 18 and transfer cylinders 19 to 22, the press units 11 to 14 have inking units (not shown) and optionally damping units. In the printing unit 10 of FIG. 1, each forme cylinder 15 to 18 of each press unit 11 to 14 rolls on the respective transfer cylinder 19 to 22 of the corresponding press unit 11 to 14, all of the transfer cylinders 19 to 22 of all of the press units 11 to 14 rolling on a common impression cylinder 23. Accordingly, the printing unit of FIG. 1 is configured as what is known as a nine-cylinder printing unit.

In the printing unit 10, a web-shaped printing material 24 is printed in the region of each press unit 11 to 14 with single-color printed images in one printing color, the printing material 24 being moved through between the transfer cylinders 19 to 22 and the impression cylinder 23 for this purpose, according to FIG. 1. Here, first single-color printed images are applied in the region of the printing unit 11 to the printing material 24, and further single-color printed images are printed one after another in the press units 12, 13 and 14 onto the printing material 24, it being necessary, in particular, to minimize displacements in the circumferential register between the single-color printed images in order to achieve as high a print quality as possible, in order that the single-color printed images are printed onto the printing material 24 with exact congruence.

In the printing unit 10 of FIG. 1, the transfer cylinders 19 to 22 and the forme cylinders 15 to 18 are positioned symmetrically with respect to a vertically extending axis A-A which extends through a rotational axis or a center point of the impression cylinder 23 in the case of the nine-cylinder printing unit. As the forme cylinders 15 to 18, the transfer cylinders 19 to 22 and the impression cylinder 23 are subjected to a deflection as a consequence of their inherent weight and the contact forces which act on them during printing, a straight, horizontal line on the form cylinders 15 to 18 is shown curved on the printing material 24. Accordingly, in the printing unit 10 of FIG. 1, the deviations in the circumferential register which are shown in FIG. 2 result between the single-color printed images which are to be printed in the press units 11 to 14. In FIG. 2, the axial extent of the cylinders or the width of the printing-material web is plotted on the horizontal axis and the curvature of the lines which are transferred by the forme cylinders 15 to 18 relative to the transport direction of the printing material 24 is plotted on the vertical axis. The curve 25 corresponds to the curvature of a line which is printed onto the printing material 24 in the press unit 11 by the forme cylinder 15 and via the transfer cylinder 19. The curve 26 corresponds to the curvature of the line which is printed in the press unit 12 by the form cylinder 16 and via the transfer cylinder 20. In the same way, a straight, horizontal line on the forme cylinder 17 in the press unit 13 becomes the arched curve 27 during the transfer of ink via the transfer cylinder 21, and a straight, horizontal line on the forme cylinder 18 in the press unit 14 becomes the arched curve 28 on the printing material 24 during the transfer of ink via the transfer cylinder 22. The vertical spacing between the curves 25 to 28 corresponds to the deviation in the circumferential register at the respective axial position of the printing material between the single-color printed images which are to be printed in the press units 11 to 14. Here, in particular, the deviations in the circumferential register between the press units which are passed through by the printing material 24 in a different transport direction are particularly large. It can thus be gathered from FIG. 1 that the transport direction of the printing material 24 changes between the press units 12 and 13, for which reason the deviations in the circumferential register between the press units 11 and 13, 11 and 14, 12 and 13 and 12 and 14 are greater than the deviations in the circumferential register between the press units 11 and 12 and 13 and 14.

In order to minimize deviations in the circumferential register, it is proposed within the context of the present invention to position or arrange the forme cylinders and/or the transfer cylinders of a printing unit asymmetrically.

FIG. 3 therefore shows a first exemplary embodiment of a printing unit 29 according to the invention of a web-fed rotary press which is configured as a nine-cylinder printing unit, that is to say which comprises four press units 30 to 33 and, accordingly, four forme cylinders 34 to 37 and four transfer cylinders 38 to 41 and one impression cylinder 42. The transfer cylinders 38 to 41 of all the press units 30 to 33 role on the common impression cylinder 42, a web-shaped printing material 43 being moved through between the transfer cylinders 38 and 41 and the impression cylinder 42, in order to print a single-color printed image onto the printing material 43 in the region of each press unit 30 to 33. The forme cylinders 34 to 37 of the respective press unit roll on the transfer cylinders 38 to 41 of each press unit 30 to 33.

In the exemplary embodiment of FIG. 3, the forme cylinders 34 to 37 are arranged symmetrically with respect to a vertically extending axis A-A which extends through a rotational axis or a center point 44 of the impression cylinder 42. In contrast, the transfer cylinders 38 to 41 are positioned asymmetrically relative to this vertical axis A-A. Here, the transfer cylinders 38 to 41 are arranged asymmetrically with respect to one another, in such a way that, for all the press units 30 to 33, the sum of the tangential displacements between the forme cylinders 34 to 37 and the associated transfer cylinders 38 to 41, and between the transfer cylinders 38 to 41 and the impression cylinder 42, are curved uniformly and, in relation to the transport direction of the printing material 43, in the same direction. In the exemplary embodiment of FIG. 3, rolling regions 45 of the transfer cylinders 38 to 41 lie on the impression cylinder 44 in the region of all the press units 30 to 33, in relation to the transport direction of the printing material 43, downstream of and behind a connecting line of the respective press unit 30 to 33, which connecting line extends through center points 46 of the forme cylinders 34 to 37 and through the center point 44 of the impression cylinder 42. FIG. 3 shows these connecting lines between the center point 44 of the impression cylinder 42 and the center points 46 of the forme cylinders 34 to 37 of the press units, with dashed lines. The rolling regions 45 of the transfer cylinders 38 to 41 of each press unit and the impression cylinder 42 lie downstream of or behind these connecting lines, in relation to the transport direction of the printing material 43.

As has already been mentioned, in the exemplary embodiment of FIG. 3, the rolling regions between the transfer cylinders and the impression cylinder are positioned in the region of each press unit downstream of the connecting lines between the forme cylinder and impression cylinder, in relation to the transport direction of the printing material. As an alternative to this, it is also possible to position the transfer cylinders asymmetrically in such a way that these rolling regions lie upstream or in front of the connecting lines between the forme cylinders and the impression cylinder, in relation to the transport direction.

In the exemplary embodiment of FIG. 3, the printing unit is configured as a nine-cylinder printing unit. In the context of the present invention, it is also possible to configure the printing unit as a ten-cylinder printing unit, two impression cylinders then being present in this case. In this case, in each case two transfer cylinders of two press units then roll on both impression cylinders, the impression cylinders being positioned symmetrically with respect to the vertical axis A-A. Deviations in the circumferential register can also be minimized in a ten-cylinder printing unit of this type by a correspondingly asymmetric positioning of the forme cylinders and/or transfer cylinders.

FIG. 4 shows a further exemplary embodiment of the printing unit 47 according to the invention, the printing unit 47 also being configured as a nine-cylinder printing unit, in the same way as the printing unit 29 of FIG. 3. In order to avoid unnecessary repetitions, identical reference numerals are used for identical assemblies and only those details are discussed in the following text, by way of which the exemplary embodiment of FIG. 4 differs from the exemplary embodiment of FIG. 3.

In the exemplary embodiment of FIG. 4, both the forme cylinders 34 to 37 and the transfer cylinders 38 to 41 are positioned asymmetrically, namely asymmetrically with respect to the vertically extending axis A-A which extends through the center point 44 of the impression cylinder 42 in the nine-cylinder printing unit. Here, the transfer cylinders 38 to 41 and the forme cylinders 34 to 37 are again arranged or positioned asymmetrically in such a way that, for all the printing units 30 to 33, the sum of the tangential displacements between the forme cylinders 34 to 37 and the associated transfer cylinders 38 to 41, and between the transfer cylinders 38 to 41 and the impression cylinder 42, is curved uniformly and, in relation to the transport direction of the printing material 43, in the same direction, that is to say, therefore, rolling regions of the transfer cylinders 38 to 41 lie in the region of all the press units 30 to 33 on the impression cylinder 42 either downstream of and behind or upstream and in front of a connecting line between the forme cylinders 34 to 37 and the impression cylinder 42.

Although not shown in the figures, it is also possible to position only the forme cylinders of the press units asymmetrically with respect to the vertically extending line A-A, and in contrast to arrange the transfer cylinders symmetrically with respect to this vertically extending axis A-A. Within the context of the invention, it is also possible in this way to minimize deviations in the circumferential register between single-color printed images which are to be printed onto the printing material in the press units.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing unit of a web-fed rotary press, the printing unit comprising a plurality of press units and at least one impression cylinder, each said press unit comprising:
a forme cylinder bearing a plurality of printing images next to each other in an axial direction, each said printing image corresponding to a single color printed image applied to a printing material; and
a transfer cylinder rolling on an impression cylinder in a thrown-on position of the printing unit in order to transfer ink from the printing images on a respective said forme cylinder to a printing material moving between the transfer cylinders and the at least one impression cylinder, thereby forming printed images;
wherein the form cylinders and/or the transfer cylinders are positioned asymmetrically.

2. The printing unit of claim 1 wherein both the forme cylinders and the transfer cylinders are positioned asymmetrically.

3. The printing unit of claim 1, wherein the forme cylinders are positioned asymmetrically, and the transfer cylinders are positioned symmetrically.

4. The printing unit of claim 1 wherein the transfer cylinders are positioned asymmetrically, and the forme cylinders are positioned symmetrically.

5. The printing unit of claim 1 wherein the forme cylinders and/or the transfer cylinders are positioned asymmetrically with respect to a vertically extending axis.

6. The printing unit of claim 5 having only one impression cylinder, the vertical axis extending through a center point of the impression cylinder.

7. The printing unit of claim 5 having two impression cylinders positioned symmetrically with respect to the vertical axis.

8. The printing unit of claim 1 wherein each press unit has a connecting line extending through the center of the forme cylinder and the center of the impression cylinder of the respective press unit, each said transfer cylinder rolling on the respective impression cylinder either downstream or upstream of the connecting line, with respect to the direction of movement of the printing material.

9. The printing unit of claim 1 wherein the forme cylinders and the transfer cylinders are positioned so that the sum of the tangential displacements between the forme cylinders and the respective transfer cylinders, and between transfer cylinders and the respective impression cylinder, are curved uniformly and in the same direction in relation to thee direction of movement of the printing material.

10. The printing unit of claim 1 wherein the printing unit is a nine cylinder printing unit having four forme cylinders, four transfer cylinders, and a single impression cylinder.

11. The printing unit of claim 1 wherein the printing unit is a ten cylinder printing unit having four forme cylinders, four transfer cylinders, and two impression cylinders.
